(19) United States
(12) Patent Application Publication
(10) Pub. No.: US 2013/0037224 A1
(43) Pub. Date: Feb. 14, 2013

(54) Multi-Slat Combination Blind of Up-Down-Movement Type

(71) Applicant: Yifei Zhang, Hangzhou (CN)

(72) Inventor: Yifei Zhang, Hangzhou (CN)

(73) Assignee: HANGZHOU WOKASOLAR TECHNOLOGY CO., LTD., Hangzhou, Zhejiang (CN)

(21) Appl. No.: 13/695,074

(22) PCT Filed: Apr. 29, 2011
(86) PCT No.: PCT/CN2011/073552

§ 371 Date: Oct. 29, 2012

(30) Foreign Application Priority Data
Apr. 30, 2010 (CN) 201010162501.1

(51) Int. Cl. E06B 9/30

(52) U.S. Cl. 160/220; 160/218

(57) ABSTRACT

The disclosed is a multi-slat combination blind of up-down-movement type which includes a main slat (1) and a lifting slat (2). The cross section of the lifting slat (2) in the width direction has the same shape as that of the main slat (1) in the width direction. The lifting slat (2) is attached on the upper or lower surface of the main slat (1). The lifting slat (2) can be driven to lift together with the main slat (1) and also to lift relative to the main slat (1) by a lifting mechanism. Various sun-shading and light-guiding blind systems formed by the multi-slat combination bind of up-down-movement type can achieve the optimization of controlling retro-reflection and guiding volume of direct sunlight according to season change and specific requirements of persons. High transparency is simultaneously kept whether solar elevation angle is high or low.

### CROSS REFERENCE TO RELATED PATENT APPLICATION

The present application is the US national stage of PCT/CN2011/073552 filed on Apr. 29, 2011, which claims the priority of the Chinese patent application No. 201010162501.1 filed on Apr. 30, 2010, which application is incorporated herein by reference.

### FIELD OF THE INVENTION

The present invention relates to a kind of blind structure for blocking or guiding light, specifically, relates to a kind of multi-slat combination blind of up-down-movement type.

### BACKGROUND OF THE INVENTION

Blind allows too much direct sunlight into room near window, resulting in glare near the window and indoor overheat, but insufficient bright at deep room. It is impossible to bright a big office evenly enough illumination by natural light with commercial blinds available in current market. In sunshine day, sunlight is kept out to reduce the light and heat into the interior space, which causes office too dark, and artificial lighting has to be used to get bright enough illumination. That results in more energy expense, people's uncomfortableness and lower work efficiency. Therefore, a new kind of sun-shading and light-guiding blind is invented. This invention can anti-glare and prevent overheating as commercial blind, also guide the sunlight into deep room, which makes the room lighted by sunlight evenly, and heated by sunlight in winter to reduce the heating costs.

Generally speaking, sun-shading and light-guide blind may be divided into upper and lower two parts (usually the boundary between upper and lower part takes human-height as benchmark, which is 1.9 m in West and 1.8 m in Asia properly), the slat rotating angle of these two parts may be dependent or independent. Usually the lower slat may be set as anti-glare and prevention overheating, and the upper slat may be set to import the light into deep room. Besides increasing design cost, this system has a fault—the functions of two parts, anti-glare or guiding light, are defined in advance, therefore cannot be adjusted according to users, seasons and specific lighting condition of workplace.

Indoor illumination condition depends upon not only seasons, sun position, sky condition (cloudy or sunny), but also working condition, such as work types, height, work location, and distance from the window. Obviously, sun-shading and light-guiding blind defined by architects and architectural lighting engineers cannot meet all above-mentioned requirements but a compromise among them. In addition, the costs of design and blind are increased seriously if different blinds were installed for different situations.

European patent (EP0400662B1) presents a light-deflecting venetian blind, which slats are each subdivided into at least two slat portions—slat outside and slat inside—extending in the slat longitudinal direction, They are linked by rotating shaft; and their activities are controlled by rope respectively. First Portion of Blinds can block sunlight to outdoor by rotating to special position, and second Portion of Blinds can guide sunlight to deep room if necessary. Based on EP0400662B1, Germany patent (DE29814826U1) introduces artificial fiber hinged film brackets whose shapes are close to each slat's radian shape. Rope can easily control two slats' rotation around hinge. Germany patent (DE10147523A1) makes improvement on the rope control structure based on European patent (EP0400662B1), finding a better rope control structure for blind. However, these patents did not consider the combination blind's transparency, retro-reflection, deflection light guiding and optimal light adjustment according to personalize demands for direct sunlight.

European patent (EP1212508B1) describes sunlight guiding blinds with at least partly prism-molded toothed upper sides. The curved slat with teeth and the W-shaped slat showed excellent properties respectively on retro-reflection, light-guiding and transparency. The transparency of W-shaped blind can reach 74%, while that of curved blind with teeth can reach 88%. But these blinds cannot meet the above season changing and specific needs—Blind is demanded to keep higher transparency while low solar elevation angle, and while more sunlight is required to guide into room, the blind has to be close to prevent glare.

### SUMMARY OF THE INVENTION

Technical problem to be solved by this present invention: a kind of multi-slat blind of up-down-movement type, which can optimize blocking or guiding direct sunlight flexibly according to different seasons, weather conditions, and the personalized demands, can illuminate room evenly by natural sunlight, avoid glare, avoid overheating in summer, and obtain more solar energy for indoor heating in winter.

The specific techniques in this invention are as follows:

A multi-slat combination blind of up-down-movement type includes the main slat and the lifting slat, which cross section shape is the same as that of the main slat and is set close to the upper side or the underside of the main slat, the lifting slat not only lifts along with the main slat, but also lifts relative to the main slat driven by lifting mechanism, the upper side of the main slat has micro-teeth partially or wholly, the upper side of the lifting slat has micro-teeth partially or wholly.

Wherein the lifting slat is composed of two slats; the lifting slats are set close to the upper side or the underside of the main slat in turn, Wherein the upper side of the lifting slat has micro-teeth partially or wholly.

Wherein the multi-slat combination blind includes sun-shading slat, which installed under the main slat and can be furled close to the underside of the main slat, the sun-shading slat can be spread to block or retro-reflect sunlight back to the outer space while low solar elevation angle in winter and summer.

Wherein the main slat has V-shaped, line-shaped, arc-shaped or wave-shaped cross section.

Wherein the main slat and the lifting slat may be rotatable.

Wherein the main slat may be foldable.

Wherein the cross section of the main slat may be zigzagged.

Wherein the micro-teeth are retro-reflection teeth, including two adjacent orthogonal tooth surfaces: the first tooth surface and the second tooth surface, the variation range of included angle α_{H} between the second tooth surface of the retro-reflection teeth, which play a role of retro-reflecting direct sunlight, and the horizontal plane is 90°−(β_{ia′}+H)/2≦α_{H}≦90°−(βᵢₐ+H)/2, in which H is solar elevation angle, β_{ia′} is the included angle between the horizontal plane and the line, linking any edge on the upper side of slat and the edge on the outer space of the adjacent upper slat, βᵢₐ is the included angle between the horizontal plane and the line, linking any edge on the upper side and the edge on the outer space on the upper side of the slat.

Wherein the micro-teeth are forward or backward teeth, including two adjacent orthogonal tooth surfaces: the first tooth surface and the second tooth surface, the variation range of included angle α_{H} between the second tooth surface of forward or backward teeth, which play a role of guiding sunlight, and the horizontal plane is (β_{ic}−H)/2≦α_{H}≦(β_{ic′}−H)/2, in which H is solar elevation angle, β_{ic} is the included angle between the horizontal plane and the line, linking any edge on the upper side and the edge on the interior space of slat, β_{ic′} is the included angle between the horizontal plane and the line, linking any edge on the upper side of the slat and the edge on the interior space of the adjacent upper slat.

The uniqueness of the present invention: all kinds of blinds—sun-shading and light-guiding system composed of any shaped in cross section multi-slat of up-down-movement type, can optimize blocking and guiding sunlight according to different seasons and personalized requirements, can fit different demands for sunlight in summer and winter, can keep high transparency either with high or low solar elevation angle to satisfy people's visual needs—good view through window. Current commercial blinds have to be adjusted frequently according to sun elevation angle changing in daytime while these new sunlight self-adapting blinds only can be operated twice a day, which is benefit for intelligent control.

### BRIEF DESCRIPTION OF THE DRAWINGS

FIG. 1a-FIG. 1d Cross section of wave-shaped blind and definition of angles and dimensions,

FIG. 2a-FIG. 2c Schematic diagrams of action and sunlight reflection of two wave-shaped slats combination blind (over 1.8 m above indoor ground) according to different solar elevation angle,

FIG. 3a-FIG. 3c Schematic diagrams of action and sunlight reflection of two wave-shaped slats combination blind (below 1.8 m above indoor ground) according to different solar elevation angle,

FIG. 4a-FIG. 4b Schematic diagrams of action and sunlight reflection of two wave-shaped slats combination blind with sun-shading component according to different solar elevation angle,

FIG. 5a-FIG. 5b Schematic diagrams of action and sunlight reflection of two rotatable wave-shaped slats combination blind according to different solar elevation angle,

FIG. 6a-FIG. 67b Schematic diagrams of action and sunlight reflection of two wave-shaped slats combination blind whose main slat is foldable according to different solar elevation angle,

FIG. 7a-FIG. 7c Schematic diagrams of action and sunlight reflection of three wave-shaped slats combination blind (over 1.8 m above indoor ground) according to different solar elevation angle,

FIG. 8a-FIG. 8c Schematic diagrams of action and sunlight reflection of three wave-shaped slats combination blind (below 1.8 m above indoor ground) according to different solar elevation angle,

FIG. 9a-FIG. 9d Definition of micro-teeth toothed face angle on curved surface that retro-reflects and guides sunlight,

FIG. 10a-FIG. 10f Type and distribution of micro-teeth on surface of plane slat,

FIG. 11a-FIG. 11d Type and distribution of micro-teeth on surface of symmetrical V-shaped slat,

FIG. 12a-FIG. 12d Type and distribution of micro-teeth on the surface of the arc-shaped slat,

FIG. 13a-FIG. 13d Type and distribution of micro-teeth on the surface of the wave-shaped slat,

FIG. 14a-FIG. 14d Type and distribution of micro-teeth on the surface of the V-shaped slat,

FIG. 15 Definition of tangent angle θᵢ on arc, the choral height h and the choral length L of the arc-shaped slat,

FIG. 16 Definition of tangent angle θᵢ on arc, the choral height h and the choral length L of the wave-shaped slat,

FIG. 17a-FIG. 17d Schematic diagrams of two symmetrical V-shaped slats combination blind (γ₁=−5°, γ₂=5°) retro-reflects and guides sunlight according to different solar elevation angle H in summer and winter,

FIG. 18a-FIG. 18b Schematic diagrams of two symmetrical V-shaped slats combination blind (γ₁=−5°, γ₂=5°) whose main slat is foldable, retro-reflects and guides sunlight (over & below 1.8 m above indoor ground) while solar elevation angle H=20°,

FIG. 19a-FIG. 19b Schematic diagrams of two plane slats combination blind with sun-shading slat retro-reflects and guides sunlight (over & below 1.8 m above indoor ground) while solar elevation angle,

FIG. 20a-FIG. 20b Schematic diagrams of two rotatable symmetrically V-shaped slats combination blind (γ₁=−5°, γ₂=5°) retro-reflects and guides sunlight (over & below 1.8 m above indoor ground) while solar elevation angle H=20°,

FIG. 21a-FIG. 21c Schematic diagrams of three plane slats combination blind retro-reflects and guides sunlight while low solar elevation angle H,

FIG. 22a-FIG. 22b Schematic diagrams of two zigzagged plane slats combination blind with sun-shading slat retro-reflects and guides sunlight (over & below 1.8 m above indoor ground) while solar elevation angle H=20°,

FIG. 23a-FIG. 23c Type and distribution of teeth on the surface of the zigzagged plane slat,

FIG. 24a-FIG. 24c Three hinge locations between the sun-shading slat and two-slat combination blind,

### DETAILED DESCRIPTION OF THE INVENTION

Referring to the figures and embodiments, the invention is described in detail as follows.

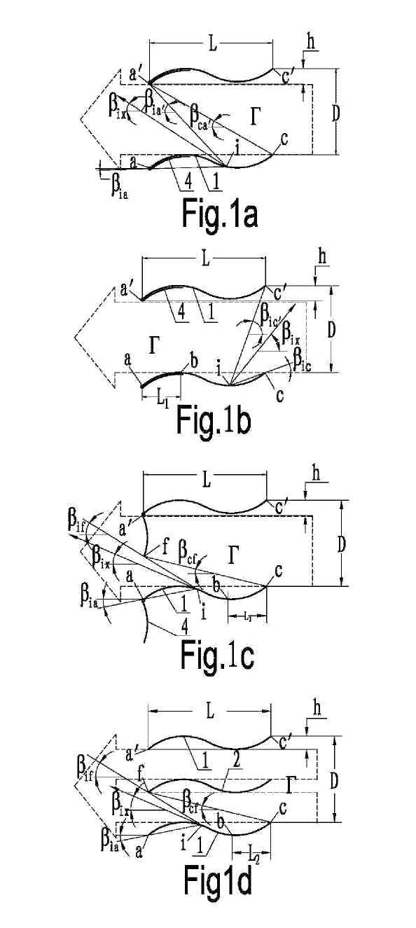

FIG. 1a-FIG. 1d show cross sections (width direction) giving definitions of geometric shape, angles and dimensions of a wave-shaped slat, wherein the slat is a main slat 1 or a lifting slat, L is the width of the slat, that is horizontal distance between the edge a on the outer space and the edge c on the interior space of the slat, the pitch D is the distance between two adjacent slats, that is the vertical distance between the edges c on the interior space of two adjacent slats, and the optimal ratio between the pitch D and the width L is 0.7, h is vertical distance between the highest edge c and the lowest edge a′ of the slat when displaced, and Γ is the transparency of the blind (Γ=1−h/D) shown as hidden-lined arrow in FIG. 1. L₁ is the horizontal distance between the edge b on the upper side and the edge a on the outer space of the slat (how to select the edge b is described following), L₂ is the horizontal distance between the said edge b and the edge c on the interior space of the slat. β_{ca′} in FIG. 1a is the included angle between the line, linking the edge c on the interior space of the slat and the edge a′ on the outer space of the adjacent upper slat, and the horizontal plane. β_{ia′} is the included angle between the line, linking any edge i on the upper side of the slat and the edge a′ on the outer space of the adjacent upper slat and the horizontal plane. βᵢₐ is the included angle between the line, linking any edge i on the upper side and the edge a on the outer space of the slat, and the horizontal plane. βᵢₓ is the included angle between sunlight reflection at any edge i on the upper side of the slat and the horizontal plane. β_{ic′} in FIG. 1b is the included angle between the line, linking any edge i on the upper side of the slat and the edge c′ on the interior space of the adjacent upper slat, and the horizontal plane. β_{ic} is the included angle between the line, linking any edge i on the upper side and the edge c on the interior space of the slat, and the horizontal plane. β_{cf} in FIG. 1c is the included angle between the line, linking the edge c on the interior space of the slat and the free edge f of the full open sun-shading component, and the horizontal plane. β_{if} is the included angle between the line, linking any edge i on the upper side of the slat and the free edge f of the full open sun-shading slat 4, and the horizontal plane. β_{cf} in FIG. 1d is the included angle between the line, linking the edge c on the interior space of the main slat 1 and the edge f on the outer space of the lifting slat 2, and the horizontal plane, when the lifting slat 2 moves down to middle of two main slats 1.

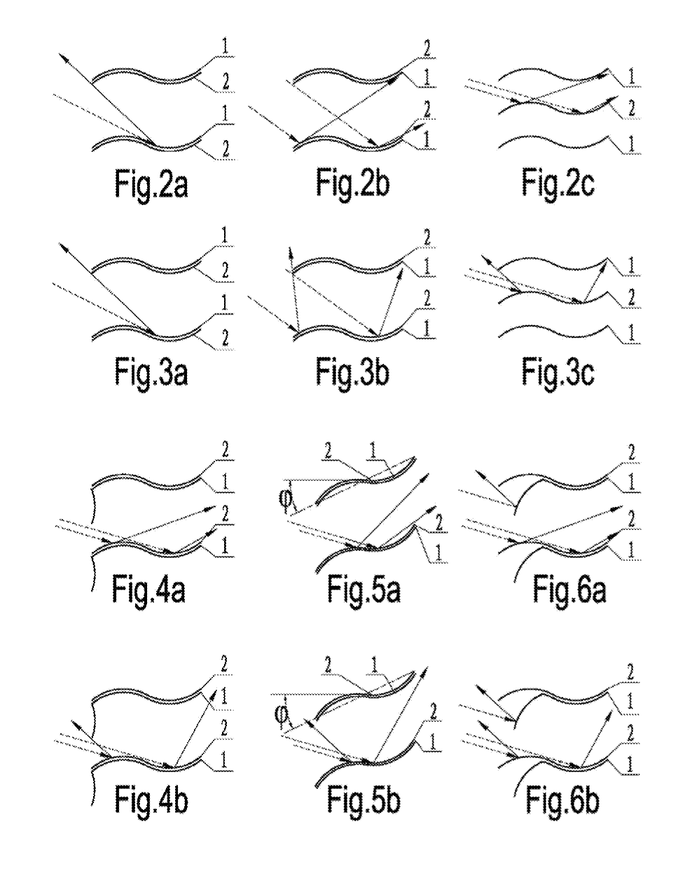

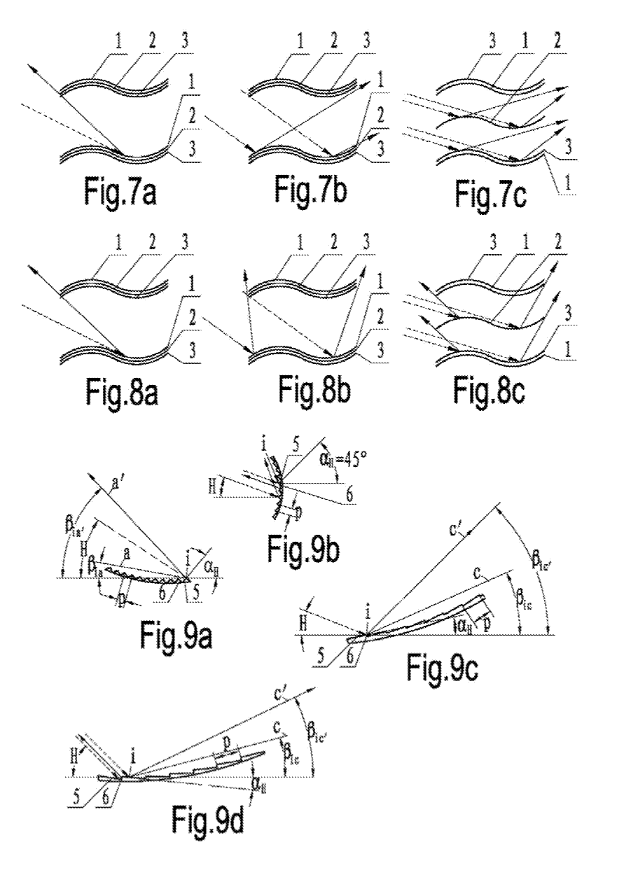

FIG. 2 and FIG. 3 respectively show schematic diagrams of action and sunlight reflection of two wave-shaped slats combination blind according to different solar elevation angle H (solar elevation angle is the included angle between solar incident direction and the horizontal plane). Solar elevation angle H is divided into three areas: H>β_{ca′} in summer, H>β_{ca′} in winter and H≦β_{ca′} in winter & summer. FIG. 2 shows the slats located over 1.8 m above indoor ground. FIG. 3 shows the slats located below 1.8 m above indoor ground. FIG. 2a shows relationship between sunlight reflection and the slat while solar elevation angle H>β_{ca′} in summer, i.e. the included angle βᵢₓ between the sunlight reflection to the outer space at any edge i on the upper side of the slat and the horizontal plane is (βᵢₐ+H)/2≦βᵢₓ≦(β_{ia′}+H)/2, FIG. 2b shows relationship between sunlight reflection and the slat while solar elevation angle H>β_{ca′} in winter, i.e. the included angle βᵢₓ between the sunlight guiding to the interior space at any edge i on the upper side of the slat and the horizontal plane is 90°+(β_{ic}−H)/2≦βᵢₓ≦90°+(β_{ic′}−H)/2, FIG. 2c shows relationship between the sunlight and the slat while solar elevation angle H≦β_{ca′} in winter & summer, i.e. the included angle βᵢₓ between the sunlight reflection to the outer space at any edge i on the upper side of the first portion of the slat and the horizontal plane is (βᵢₐ+H)/2≦βᵢₓ≦(β_{if}+H)/2, and the included angle βᵢₓ between the sunlight guiding to the interior space at any edge i on the upper side of the slat and the horizontal plane is 90°+(β_{ic}−H)/2≦βᵢₓ≦90°+(β_{ic′}−H)/2. In addition to the above relationship between the sunlight and the slat while solar elevating angle H≦β_{ca′} in winter & summer, FIG. 4-FIG. 6 also show another three solutions, i.e. with the sun-shading component (referring to FIG. 4), the rotatable slat (referring to FIG. 5), and the foldable main slat (referring to FIG. 6), wherein FIG. 4a-FIG. 6a are the slats located over 1.8 m above indoor ground, and FIG. 4b-FIG. 6b are the slats located below 1.8 m above indoor ground, FIG. 7 and FIG. 8 respectively show schematic diagrams of the sunlight reflection and action of each slat of three wave-shaped slats combination blind according to three different solar elevation angle H comparing to FIG. 2 and FIG. 3.

Referring to FIG. 2 and FIG. 3, two-slat combination blind of up-down-movement type consists of a main slat 1, a lifting slat 2, and a driving system (not shown in Figure). The cross section of the main slat 1 may be arbitrary shape, such as wave-shaped, V-shaped, plane, arc-shaped, and etc. The upper side of the main slat 1 and the lifting slat 2 can be smooth or micro-toothed (small saw teeth) (see FIG. 9 to FIG. 14), and the underside of the main slat 1 and the lifting slat 2 is smooth. In this embodiment, the main slat 1 can be lift up-down but not rotated, and cross section shape of the lifting slat 2 is the same as that of the main slat 1. Normally, the lifting slat 2, being close to upper- or underside of the main slat 1, can move up and down with the main slat 1 or separately relative to the main slat 1. The lifting slat 2 is close to the underside of the main slat 1 and the micro-teeth on the upper side of the main slat 1 retro-reflect sunlight to the outer space while high solar elevation angle H>β_{ca′} in summer, during the lifting slat 2 moves down to the upper side of the main slat 1 from the underside of the adjacent upper main slat 1, the micro-teeth on the upper side of the slat guide sunlight to the interior space wholly, or retro-reflect part of sunlight to the outer space and guide the rest sunlight to the interior space while high solar elevation angle H>β_{ca′} in winter. The lifting slat 2 moves to the middle of two adjacent main slats 1 and the micro-teeth on the upper side of the slat retro-reflect sunlight to the outer space partly and guide the rest to the interior space, or guide sunlight to the interior space wholly while low solar elevation angle H≦β_{ca′} in winter and summer.

Referring to FIG. 7 and FIG. 8, three-slat combination blind of up-down-movement type is to improve two-slat combination blind. Comparing to two-slat combination blind of up-down-movement type, three-slat combination blind has two lifting slats: the lifting slat 2 and 3, which are close to the upper- or the underside of the main slat 1 one by one and can move up and down with the main slat 1 or separately relative to the main slat 1. In summer lifting slat 2 and 3 are close to the underside of the main slat 1, and the micro-teeth on the upper side of the main slat 1 retro-reflect sunlight to the outer space while high solar elevation angle H H>β_{ca′}. In winter the lifting slat 2 moves down to the upper side of the main slat 1 from the underside of the adjacent upper main slat 1 and the micro-teeth on the upper side of the slat guide sunlight to the interior space or retro-reflect sunlight to the outer space partly and meanwhile the lifting slat 3 is still close to the underside of the main slat 1 while high solar elevation angle H>β_{ca′}, In summer and winter the lifting slat 2 moves down to the lower adjacent main slat 1, meanwhile the lifting slat 3 moves to the middle of two adjacent main slats bisecting the space between the said two adjacent main slats and the micro-teeth on the upper side of the slat retro-reflect sunlight to the outer space partly and guide the rest to the interior space, or retro-reflect sunlight to the outer space wholly while low solar elevation angle H≦β_{ca′}.

FIG. 4 shows two-slat combination blind of up-down-movement type with sun-shading component. Different with two-slat combination blind of up-down-movement type, it has sun-shading component. It includes the main slat 1, the lifting slat 2 and the sun-shading component 4, which may be a sun-shading slat 4, and shape of the sun-shading slat 4 matched that of the main slat 1. The sun-shading slat 4 may be a rotating flat-plate or arc-shaped slat, and the reflective side is smooth or micro-toothed. The sun-shading slat 4 is hinged on any edge of the underside of the main slat 1. The main slat 1 cannot rotate but move up and down. The cross section of the lifting slat 2 has the same shape as that of the main slat 1. Normally, the lifting slat 2, being close to the surface of the sun-shading component, can move up and down with the main slat 1 or separately relative to the main slat 1. In summer the lifting slat 2 is close to the underside of the main slat 1 and the micro-teeth on the upper side of the main slat 1 retro-reflect sunlight to the outer space, meanwhile, the sun-shading slat 4 is furled close to the underside of the main slat 1 while high solar elevation angle H>β_{ca′}; In winter the lifting slat 2 moves down to the upper side of the main slat 1 from the underside of the adjacent upper main slat 1, and the micro-teeth on the upper side of the slat guide sunlight to the interior space partly or wholly, meanwhile the sun-shading slat 4 is furled close to the underside of the main slat 1 while high solar elevation angle H>β_{ca′}; In summer and winter the roller blind 4 or the sun-shading slat 4 is spread to block or retro-reflect sunlight to the outer space partly, meanwhile, the lifting slat 2 moves down to the upper side of the main slat 1, and the micro-teeth on the upper side of the lifting slat retro-reflect sunlight to the outer space partly and guide the rest to the interior space, or guide sunlight to the interior space wholly while low solar elevation angle H≦β_{ca′}.

FIG. 24 shows three different locations of the sun-shading slat 4 hinging on two-slat combination blind are the edge on the outer space, the bottom and the edge on the interior space of the main slat 1, that is to say, the sun-shading slat may be located at different location according to different requirements.

The Width of the sun-shading slat 4 is determined by solar elevation angle H=β_{cf}. Normally, it is able to block sunlight while H varies from 20° to 35°. If β_{cf}=20° is taken, draw an oblique line passing through the edge c on the interior space of the slat 1, β_{cf} being the angle with the horizontal plane, then draw a vertical line passing through the edge a′ on the outer space of the adjacent upper main slat 1, and these two lines intersect at f. The distance d from a′ to f is the width of the cross section of the sun-shading slat 4 (See FIG. 1).

The surface of the sun-shading slat 4 may be smooth or micro-toothed that can retro-reflect sunlight (see FIG. 24).

FIG. 5 shows a rotatable two-slat combination blind of up-down-movement type with the sun-shading component. Comparing to two-slat combination blind of up-down-movement type, it includes the main slat 1 and the lifting slat 2 while the main slat 1 and the lifting slat 2 can rotate and move up and down. In this embodiment, the upper side of the main slat 1 and the lifting slat 2 are micro-toothed and their undersides are smooth. The cross section of the lifting slat 2 has the same shape as that of the main slat 1. Normally, the lifting slat 2, close to the upper side or the underside of the main slat 1, can rotate and move up and down with the main slat 1, and the angle of slat rotation is shown as φ. In summer the lifting slat 2 is close to the underside of the main slat 1 and the micro-teeth on the upper side of the main slat 1 retro-reflect sunlight to the outer space while high solar elevation angle H>β_{ca′}; In winter the lifting slat 2 moves down to the upper side of the main slat 1 from the underside of the adjacent upper main slat 1, and the micro-teeth on the upper side of the slat guide sunlight to the interior space wholly, or retro-reflect sunlight to the outer space and guide the rest sunlight to the interior space while high solar elevation angle H>β_{ca′}; In summer and winter the lifting slat 2 moves down to the upper side of the main slat from the underside of the adjacent upper main slat 1, rotating with the main slat 1 to some angle φ from a horizontal position, so that keep sunlight out to prevent glare, and the micro-teeth on the upper side of the slat guide sunlight to the interior space wholly or partly retro-reflect sunlight to the outer space and guide the rest to the interior space while low solar elevation angle H≦β_{ca′}.

FIG. 6 shows two-slat combination blind of up-down-movement type whose main slat can be foldable. Comparing to two-slat combination blind of up-down-movement type, its main slat 1 is foldable and consists of hinged together the folding portion and the non-folding portion extending in the slat longitudinal direction. Similarly, the upper side of the main slat 1 and the lifting slat 2 are micro-toothed and their undersides are smooth. The cross section of the lifting slat 2 has the same shape as that of the main slat 1. Normally, the lifting slat 2, close to the upper side or the underside of the main slat (1), can move up and down with the main slat 1. In summer the lifting slat 2 is close to underside of the main slat 1 and the micro-teeth on the upper side of the main slat 1 retro-reflect sunlight to the outer space while high solar elevation angle H>β_{ca′}; When high solar elevation angle H is H>β_{ca′} in winter, or low solar elevation angle H is H≦β_{ca′} in summer and winter, the lifting slat 2 moves down to the upper side of the main slat from the underside of the adjacent upper main slat 1, and the micro-teeth on the upper side of the slat guide sunlight to the interior space wholly, or partly retro-reflect sunlight to the outer space and guide the rest light to the interior space, meanwhile the folding portion of the main slat 1 rotates downwards according to sunlight and plays a role of sun-shading component.

The micro-teeth on surface of the slat are divided into two: one type is to retro-reflect sunlight, and the other is to guide sunlight. FIG. 9a-FIG. 9d defines geometry and angles of the micro-teeth, which retro-reflects and guides sunlight, on arbitrary surface. FIG. 9a is definition of geometry and angles of the micro-teeth, which retro-reflect sunlight to the outer space, on arbitrary surface (so called retro-reflection teeth). FIG. 9b is definition of geometry and angles of the micro-teeth, which retro-reflect sunlight to the outer space, on arbitrary vertical surface (retro-reflection teeth). FIG. 9c is definition of geometry and angles of the micro-teeth, which guiding sunlight to the interior space, on arbitrary surface (so called forward teeth). FIG. 9d is definition of geometry and angles of the micro-teeth, which guides sunlight to interior space, on arbitrary surface (so called backward teeth). The widths p of all kinds of the micro-teeth are the same. The first tooth surface 6 and the second tooth surface 5 are adjacent and orthogonal. The included angle α_{H} between the second tooth surface 5, retro-reflecting sunlight to the outer space, and the horizontal plane is 90°−(β_{ia′}+H)/2≦α_{H}≦90°−(βᵢₐ+H)/2. The included angle α_{H} between the second tooth surface 5, guiding sunlight to the interior space, and the horizontal plane is (β_{ic}−H)/2≦α_{H}≦(β_{ic′}−H)/2, wherein H is solar elevation angle. The second tooth surface 5 of retro-reflection teeth reflects sunlight to the outer space directly, or reflects sunlight to the first tooth surface 6 then the first tooth surface 6 reflects it to the outer space or on the contrary, so that sunlight is not allowed to convert to heat on the slat, playing a role of sun-shading. It is generally used when high solar elevation angle is H (H>β_{ca′}) in summer. The second tooth surface 5 of the forward tooth is much wider than the first tooth surface 6, which guides sunlight falling on the second tooth surface 5 to the interior space for illuminating and heating in room (sunlight will not fall on first tooth surface 6 generally). The forward tooth is used when high solar elevation angle is H (H>β_{ca′}) in winter or low solar elevation angle is H (H≦β_{ca′}) in winter & summer. The second tooth surface 5 of the backward tooth is much wider than the first tooth surface 6, and these two tooth surfaces play completely different role to sunlight. One part of sunlight is reflected to the outer space by the second tooth surface 5, the rest sunlight is reflected to the first tooth surface 6 then guided to the interior space by the first tooth surface 6. The backward tooth is used when solar elevation angle H is maximum (normally, it is considered that solar elevation angle is H=45°) in winter, so that sunlight will not be reflected to the edge c′ on the interior space of the underside of the adjacent upper slat. To deal with sunlight when solar elevation angles are different in different seasons, the upper side of the slat has various types: 1. whole smooth surface (edge b is middle along cross section of the slat), 2. part of it is smooth, the rest is toothed (e.g. the first portion is the backward toothed, the second portion is smooth, the edge b is junction edge between the said the two portions), 3. the first portion of it is one kind of the micro-teeth, the second portion is another different kind of the micro-teeth (e.g. the first portion is retro-reflection toothed, the second portion is forward toothed, the edge b is junction edge between the said two portions), 4. it is covered by the same kind of the micro-teeth (e.g. all are retro-reflection teeth, the edge b is middle along cross section of the slat).

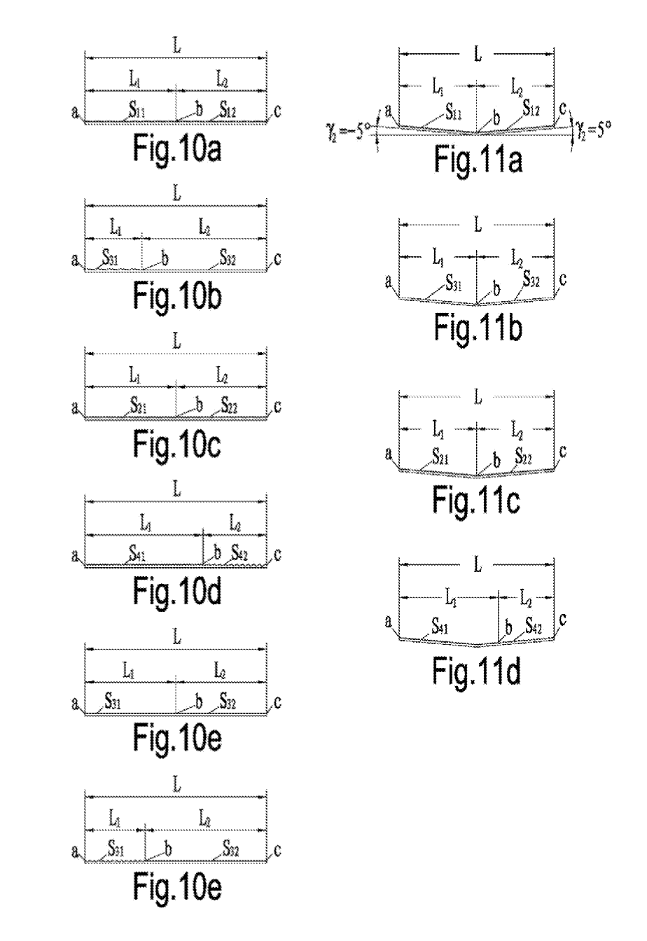

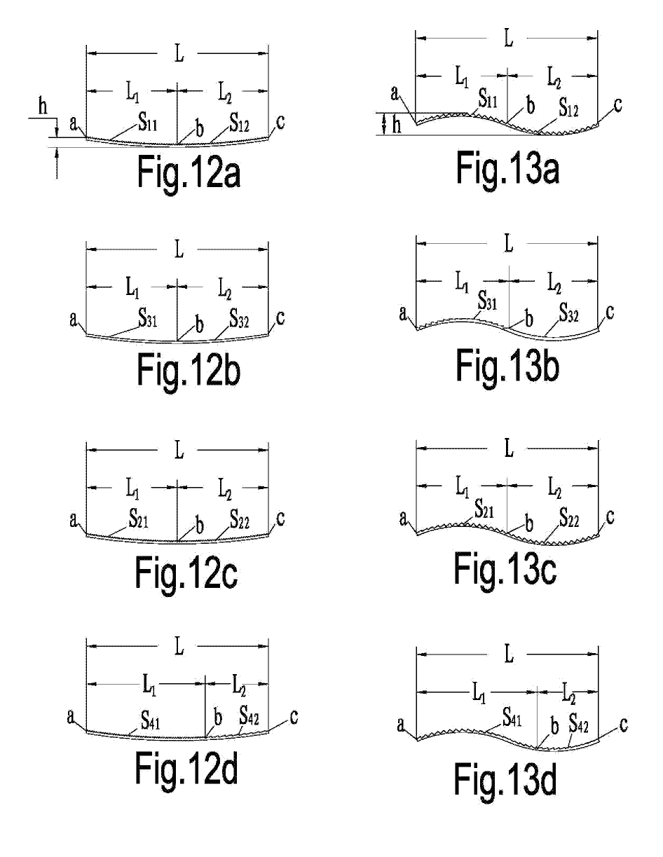

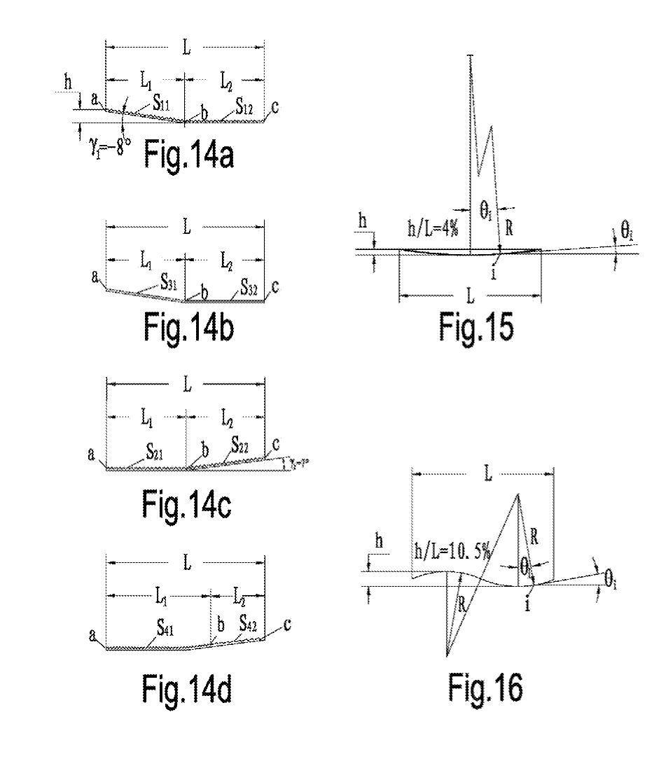

According to three different solar elevation angle areas, the upper side of multi-slat combination blind with any shaped cross section has different type of micro-teeth. The whole upper side of the main slat 1, the lifting slat 2 and 3 are shown as S. The odd subscript of S is for slats located over 1.8 m above indoor ground, while even subscript is for the slats located below 1.8 m above indoor ground. S₁ is the upper side of the main slat 1 located over 1.8 m above indoor ground, S₂ is the upper side of the main slat 1 located below 1.8 m above indoor ground, S₃ is the upper side of the lifting slat 2 located over 1.8 m above indoor ground, S₄ is the upper side of the lifting slat 2 located below 1.8 m above indoor ground, S₅ is the upper side of the lifting slat 3 located over 1.8 m above indoor ground, S₆ is the upper side of the lifting slat 3 located below 1.8 m above indoor ground. Divide the slat into first portion and second portion at the edge b, the second subscript 1 is for the first portion of the slat, whose width is L₁ measured from the edge a on the outer space of the slat, the second subscript 2 is for the second portion of the slat, whose width is L₂ measured from the edge c on the interior space of the slat. FIG. 10 shows the micro-teeth type and the distribution set on the plane slat, wherein FIG. 10a is the main slat 1 located over 1.8 m above indoor ground while solar elevation angle H>β_{ca′} in summer, whereof the upper side S₁ is covered by the retro-reflection teeth. The included angle α_{H} is between the second tooth surface 5 of the retro-reflection teeth and the horizontal plane is α_{H}=90°−(β_{ia′}+H)/2, wherein H=β_{ca′}, FIG. 10b is the lifting slat 2 located over 1.8 m above indoor ground while solar elevation angle H>β_{ca′} in winter or H≦β_{ca′} in summer and winter, whereof the first portion S₃₁ has backward teeth so that sunlight cannot be reflected to the edge c′ on the interior space of the adjacent upper slat even when solar elevation angle H is maximum) (H=45°). The included angle α_{H} between the second tooth surface 5 of the backward teeth and the horizontal plane is α_{H}=(βᵢₓ−H)/2, and (β_{ic}−H)/2≦α_{H}≦(β_{ic′}−H)/2, wherein H=45°, width L₁=0−L; the second portion S₃₂ has smooth surface. FIG. 10c is the main slat 1 located below 1.8 m above indoor ground while solar elevation angle H>β_{ca′} in summer, whereof the first portion S₂₁ and the second portion S₂₂ have retro-reflection teeth. The included angle α_{H} between the second tooth surface 5 of the retro-reflection teeth and the horizontal plane is α_{H}=90°−(β_{ia′}+H)/2, wherein H=β_{ca′}. FIG. 10d is the lifting slat 2 located below 1.8 m above indoor ground while solar elevation angle H>β_{ca′} in winter or H≦β_{ca′} in summer and winter, whereof the first portion S₄₁ has retro-reflection teeth; the included angle α_{H} between the second tooth surface 5 of the retro-reflection teeth and the horizontal plane is α_{H}=90°−(β_{if}+H)/2, wherein H=β_{cf}, the width L₁=2L/3; the second portion S₄₂ has forward teeth, and the included angle α_{H} between the second tooth surface 5 of the forward teeth and the horizontal plane is α_{H}=(β_{ic′}−H)/2, wherein H=β_{ca′}, the width L₂=L/3, so that reflected sunlight cannot reach the underside of the adjacent upper slat, and the included angle between the guided sunlight and the horizontal plane is larger than 50° while solar elevation angle is β_{cf}≦H≦β_{ca′}. As for rotatable two-slat combination blind of up-down-movement type, the first portion S₄₁ of the lifting slat 2 located below 1.8 m above indoor ground has retro-reflection teeth, and the included angle α_{H} between the second tooth surface 5 of the retro-reflection teeth and the horizontal plane is α_{H}=90°(β_{ia′}+H)/2, wherein H=β_{ca′}, width L₁=2L/3; the optimal value choice of the included angle α_{H} between the second tooth surface 5 of the second portion and the horizontal plane is to rotate shaft of the main slat 1 (around the middle of the cross section of the slat) anticlockwise by an angle φ_{cf} (φ_{cf}=β_{ca′}/2), then calculated by α_{H}=(β_{ic′}−H)/2, wherein H=β_{cf}, the width L₂=L/3. FIG. 10e and FIG. 10f is another option of FIG. 10b, FIG. 10e shows that the first portion S₃₁ and the second portion S₃₂ of the lifting slat 2 are smooth; FIG. 10f shows that the first portion S₃₁ of the lifting slat 2 has retro-reflection teeth and the second portion S₃₂ is smooth. Corresponding to FIG. 10, FIG. 11-FIG. 14 show several shapes of the cross section of a slat and their micro-teeth structure according to different solar elevation angle areas. FIG. 11 is symmetrical V-shaped, FIG. 12 is arc-shaped, FIG. 13 is wave-shaped, and FIG. 14 is V-shaped with different γ₁ and γ₂ (γ₁ or γ₂ are the included angle between the first portion or the second portion of the slat, and the horizontal plane, anticlockwise is positive, and clockwise is negative, referring to FIG. 11). The function of slat in FIG. 11a-FIG. 14a, FIG. 11b-FIG. 14b, FIG. 11c-FIG. 14c and FIG. 11d-FIG. 14d is the same as that of plane slat in FIG. 10. FIG. 15 shows ratio of the choral height h to the choral length L of the arc-shaped slat and, the definition of the angle θᵢ between the tangent line passing through any edge i on the arc and the horizontal plane. FIG. 16 shows ratio of the sum of two arcs' choral heights h to the choral length L of the wave-shaped slat, the definition of the included angle θᵢ between the tangent line passing through any edge i on the arc and the horizontal plane. The included angle between the normal line passing through this edge i and the vertical line is equal to θᵢ. Taking the said vertical line as polar axis, anticlockwise of θᵢ is positive, and clockwise is negative.

Referring to FIG. 9b, the included angle a, between the second tooth surface (5) of the retro-reflection teeth laying on the reflective surface of the sun-shading slat 4 and the horizontal plane is 45°.

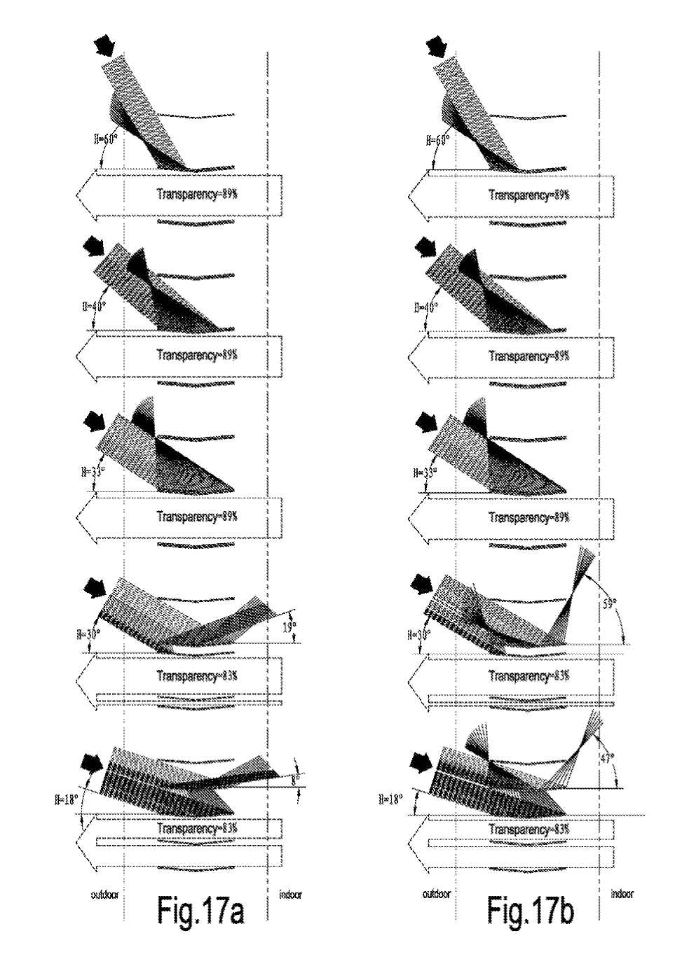

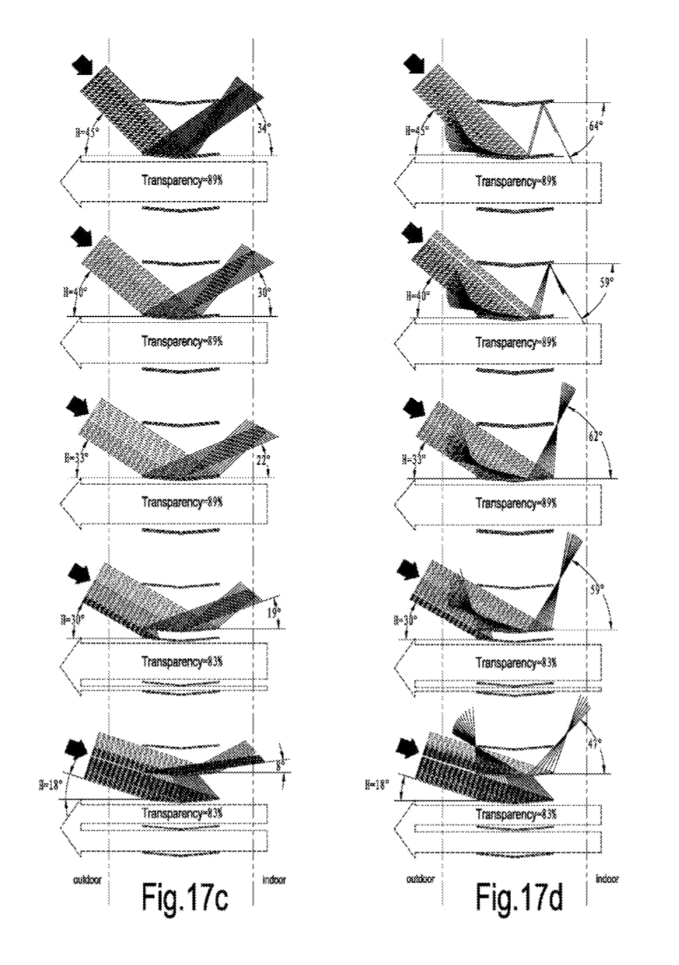

FIG. 14 shows shapes of the cross section of two V-shaped slats combination blind of up-down-movement type (γ₁=8°, γ₂=0) and (γ₁=0, γ₂=7°) and the types of the micro-teeth distributing on their upper side, wherein γ₁ is the included angle between the first portion S₁₁ of the V-shaped main slat 1 and the horizontal plane, and γ₂ is the included angle between the second portion S₁₂ of the V-shaped main slat 1 and the horizontal plane, wherein the V-shaped slat (γ₁=−8°, γ₂=0) is used for over 1.8 m above indoor ground, and the V-shaped slat (γ₁=0, γ₂=7°) is used for below 1.8 m above indoor ground (their schematic diagrams of retro-reflected and guided sunlight according to different solar elevation angle H in summer and winter are same as that of symmetrical V-shaped slats combination blinds of up-down-movement type shown in FIG. 17a-FIG. 17d. It is not shown here), which indicates that the upper (over 1.8 m above indoor ground) and the lower parts (below 1.8 m above indoor ground) of the sun-shading and guiding system can be different shape.

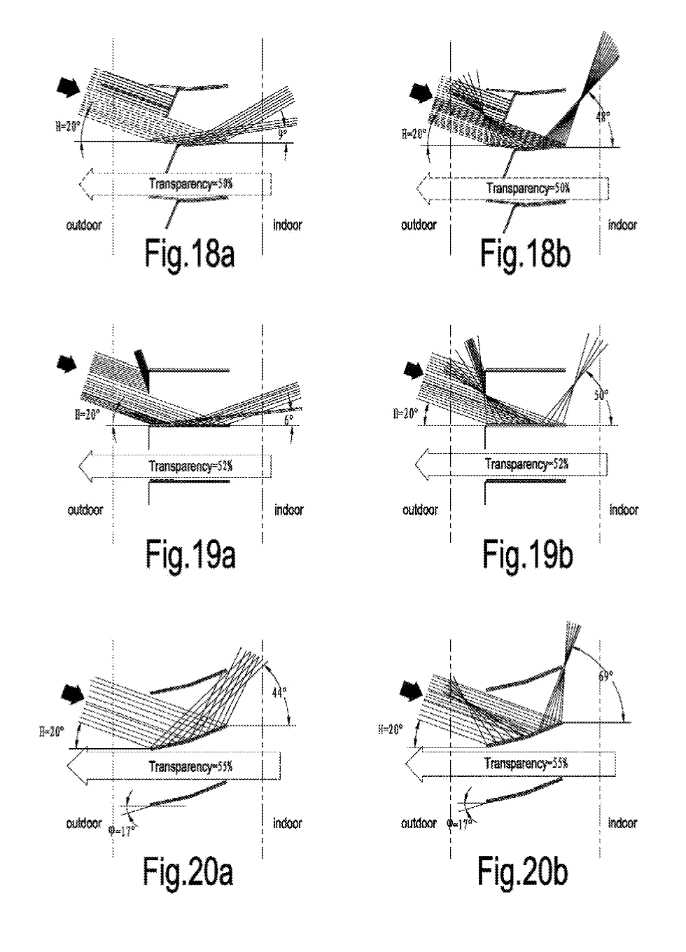

FIG. 17a-FIG. 17d respectively show schematic diagrams of retro-reflected and guided sunlight by said upper part and lower part of two symmetrical V-shaped slats combination blind of up-down-movement type according to different solar elevation angle H in summer and winter (schematic diagrams of retro-reflected and guided sunlight of the two-slat combination blind, which the main slats are symmetrical plane, arc-shape and wave-shape, are the same as that of the V-shaped slats, they are not shown here.); FIG. 18a-FIG. 18b show schematic diagrams of retro-reflected and guided sunlight by said upper part and lower part of the two symmetrical V-shape slats combination blind of up-down-movement type while solar elevation angle H=20°, wherein the main slats can be foldable (schematic diagrams of retro-reflected and guided sunlight for other solar elevation angle are not shown); FIG. 19a-FIG. 19b respectively show schematic diagrams of retro-reflected and guided sunlight by said upper part and lower part of the two plane slats combination blind and the two arc-shaped slats combination blind of up-down-movement type with the sun-shading component while solar elevation angle H=20° (schematic diagrams of retro-reflected and guided sunlight for other solar elevation angle are not shown. Schematic diagram of retro-reflected and guided sunlight for the arc-shaped slats is the same as that of the plane-shaped slats, it is not shown here.); FIG. 20a-FIG. 20b respectively show schematic diagrams of retro-reflected and guided sunlight by said upper part and lower part of the two rotatable V-shaped slats combination blind of up-down-movement type while solar elevation angle H=20°, (schematic diagrams for other solar elevation angle are not shown. Schematic diagrams for the plane-shaped and the arc-shaped slats are the same as that of the V-shaped slats, they are not shown here.). The dashed lines mean sunlight and the solid lines mean reflected or guided sunlight, and H is solar elevation angle. FIG. 17a-FIG. 20a show schematic diagrams of retro-reflected and guided sunlight by said upper part of the two-slat combination blinds of up-down-movement type according to different solar elevation angle H in summer; FIG. 17b-FIG. 20b show schematic diagrams of retro-reflected and guided sunlight by said lower part of the two-slat combination blinds of up-down-movement type according to different solar elevation angle H in summer; FIG. 17c shows schematic diagram of retro-reflected and guided sunlight by said upper part of the two-slat combination blinds of up-down-movement type according to different solar elevation angle H in winter; and FIG. 17d shows schematic diagram of retro-reflected and guided sunlight by said lower part of the two-slat combination blinds of up-down-movement type according to different solar elevation angle H in winter. Referring to these figures, the two-slat combination blinds of any shape can optimize the control of retro-reflecting and guiding sunlight depending on seasons and personalized specific needs, meanwhile provide high transparency to meet people's needs for visual communication with the outer space scenery. While solar elevation angle is H≦β_{ca′} (β_{ca′}=33°˜35°), the blinds can also have high transparency (over 50%), and control the amount of retro-reflecting and guiding of sunlight. Comparing with recent commercial sun-shading blinds, these blinds only need to be handled twice in a day to avoid the trouble of frequently adjusting as time goes by. Referring to these figures, while solar elevation angle is H≧β_{ca′} in winter, the unrotatable two-slat combination blind will reflect small part of sunlight to the edge c′ (the horizontal distance L/4 from the edge c) on the slats located below 1.8 m above indoor ground, resulting in glare. To get rid of the glare, the underside of the slat may be frosted. In FIG. 17, for the sun-shading and guiding system composed of two-slat combination blind, the lifting slat 2 moves to the middle of the two main slats 1 so that sunlight is reflected to underside of the lifting slat 2 while solar elevation angle H≦β_{ca′}. The improvement to solve such issue is to add one more lifting slat 3 to the two-slat combination blind, which is called as three-slat combination blind (in this embodiment, cross section is plane, the micro-teeth type distributing whereon referring to FIG. 10). FIG. 21 shows schematic diagrams of retro-reflects and guides sunlight of the three-slat combination blind, composed of plane slats that are shown in FIG. 10, when solar elevation angle H is low. In the Figure; FIG. 21a-FIG. 21b show schematic diagrams of retro-reflects and guides sunlight of the slats located over 1.8 m above indoor ground while low solar elevation angle H. The difference between them is that the lifting slats 2 and 3 in FIG. 21a retro-reflect partly sunlight to the outer space and guide the rest into the interior space (first portion S₃₁ and S₅₁ are covered by the retro-reflection teeth, and the included angle α_{H} between the second tooth surface 5 is α_{H}=90°−(β_{if}+H)/2, wherein H=β_{cf}, the width L₁=L/3, and the second portion S₃₂ and S₅₂ are smooth), while the lifting slats 2 and 3 in FIG. 21b almost guide all sunlight into the interior space. FIG. 21c shows schematic diagrams of retro-reflected and guided sunlight of the slats located below 1.8 m above indoor ground while low solar elevation angle H. Referring to the figures, the problem in the two-slat combination blind which reflect sunlight to the underside of the lifting slat 2 while solar elevation angle 20°≦H≦β_{ca′} in summer and winter, is solved. Referring to FIG. 20a, the rotatable two symmetrical V-shape slats combination blind located over 1.8 m above indoor ground reflect and guide sunlight to the underside of the adjacent upper slat while low solar elevation angle H=β_{cf} and high solar elevation angle H=45° in winter. Such case is caused by the lifting slat 2 covered by smooth surface (γ₁=−5°, γ₂=5°), and can be improved by the solution 1, to raise the first portion of the slat to increase γ₁, and lowering the second portion to reduce γ₂ and solution 2, to set the micro-teeth on the underside of the lifting slat 2, where results in glare.

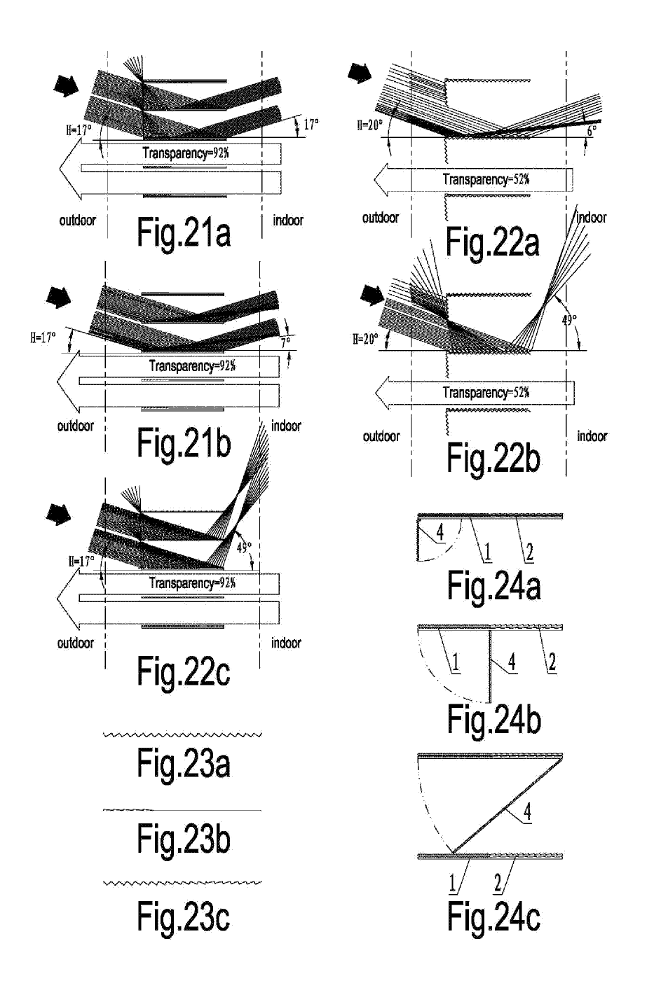

FIG. 23 shows zigzagged plane blind and micro-teeth type distributing whereon. In the figure, FIG. 23a shows slats over and below 1.8 m above indoor ground when solar elevation angle is H>β_{ca′} in summer, FIG. 23b shows slats over 1.8 m above indoor ground when solar elevation angle is H>β_{ca′} in winter and solar elevation angle is H≦β_{ca′} in winter and summer, and FIG. 23c shows slats below 1.8 m above indoor ground when solar elevation angle is H>β_{ca′} in winter and solar elevation angle is H≦β_{ca′} in winter and summer. FIG. 22a and FIG. 22b show schematic diagrams of two-slat zigzagged plane blind which retro-reflects and guides direct sunlight while solar elevation angle H=20° (schematic diagrams for other solar elevation are not shown), it is summarized that two-slat blind of up-down-movement type can be one side with micro-teeth and the other side with smooth surface, also can be zigzagged blind in terms of manufacturing procedure.

Said embodiment is optimized one not only one of recent invention. For technician in this field, some improvements or modifies basing the principle of this invention should be under the protection range of this invention.

What is claimed is:

1. A multi-slat combination blind of up-down-movement type, characterized in that it includes the main slat (1) and the lifting slat (2), which cross section shape is the same as that of the main slat (1) and is set close to the upper side or the underside of the main slat (1), the lifting slat (2) not only lifts along with the main slat (1), but also lifts relative to the main slat (1) driven by lifting mechanism, said upper side of the main slat (1) has micro-teeth partially or wholly, said upper side of the lifting slat has micro-teeth partially or wholly.

2. The multi-slat combination blind of up-down-movement type according to claim 1, characterized in that said lifting slat is composed of two slats; the lifting slats (2, 3) are set close to the upper side or the underside of the main slat (1) in turn, said upper side of the lifting slat has micro-teeth partially or wholly.

3. (canceled)

4. (canceled)

5. The multi-slat combination blind of up-down-movement type according to claim 1, characterized in that said multi-slat combination blind includes sun-shading slat (4), which installed under the main slat (1) and can be furled close to the underside of the main slat (1), the sun-shading slat (4) can be spread to block or retro-reflect sunlight back to the outer space while low solar elevation angle in winter and summer.

6. (canceled)

7. (canceled)

8. (canceled)

9. The multi-slat combination blind of up-down-movement type according to claim 1, characterized in that said main slat (1) has V-shaped, line-shaped, arc-shaped or wave-shaped cross section.

10. The multi-slat combination blind of up-down-movement type according to claim 1, characterized in that said main slat (1) and the lifting slat may be rotatable.

11. The multi-slat combination blind of up-down-movement type according to claim 1, characterized in that said main slat (1) may be foldable.

12. The multi-slat combination blind of up-down-movement type according to claim 1, characterized in that said cross section of the main slat (1) may be zigzagged.

13. (canceled)

14. The multi-slat combination blind of up-down-movement type according to claim 1 or 2, characterized in that said micro-teeth are retro-reflection teeth, including two adjacent orthogonal tooth surfaces: the first tooth surface (6) and the second tooth surface (5), the variation range of included angle α_{H} between the second tooth surface (5) of the retro-reflection teeth, which play a role of retro-reflecting direct sunlight, and the horizontal plane is 90°(β_{ia′}+H)/2≦α_{H}≦90°−(βᵢₐ+H)/2, in which H is solar elevation angle, β_{ia′} is the included angle between the horizontal plane and the line, linking any edge (i) on the upper side of slat and the edge (a′) on the outer space of the adjacent upper slat, βᵢₐ is the included angle between the horizontal plane and the line, linking any edge (i) on the upper side and the edge (a) on the outer space on the upper side of the slat.

15. The multi-slat combination blind of up-down-movement type according to claim 1 or 2, characterized in that said micro-teeth are forward or backward teeth, including two adjacent orthogonal tooth surfaces: the first tooth surface (6) and the second tooth surface (5), the variation range of included angle α_{H} between the second tooth surface (5) of forward or backward teeth, which play a role of guiding sunlight, and the horizontal plane is (β_{ic}−H)/2≦α_{H}≦(β_{ic′}−H)/2, in which H is solar elevation angle, β_{ic} is the included angle between the horizontal plane and the line, linking any edge (i) on the upper side and the edge (c) on the interior space of slat, β_{ic′} is the included angle between the horizontal plane and the line, linking any edge (i) on the upper side of the slat and the edge (c′) on the interior space of the adjacent upper slat.

16-30. (canceled)

31. The multi-slat combination blind of up-down-movement type according to claim 2, characterized in that said multi-slat combination blind includes sun-shading slat (4), which installed under the main slat (1) and can be furled close to the underside of the main slat (1), the sun-shading slat (4) can be spread to block or retro-reflect sunlight back to the outer space while low solar elevation angle in winter and summer.

32. The multi-slat combination blind of up-down-movement type according to claim 2, characterized in that said main slat (1) has V-shaped, line-shaped, arc-shaped or wave-shaped cross section.

33. The multi-slat combination blind of up-down-movement type according to claim 2, characterized in that said main slat (1) and the lifting slat may be rotatable.

34. The multi-slat combination blind of up-down-movement type according to claim 2, characterized in that said main slat (1) may be foldable.

35. The multi-slat combination blind of up-down-movement type according to claim 2, characterized in that said cross section of the main slat (1) may be zigzagged.

36. The multi-slat combination blind of up-down-movement type according to claim 2, characterized in that said micro-teeth are retro-reflection teeth, including two adjacent orthogonal tooth surfaces: the first tooth surface (6) and the second tooth surface (5), the variation range of included angle α_{H} between the second tooth surface (5) of the retro-reflection teeth, which play a role of retro-reflecting direct sunlight, and the horizontal plane is 90°−(β_{ia′}+H)/2≦α_{H}≦90°−(βᵢₐ+H)/2, in which H is solar elevation angle, β_{ia′} is the included angle between the horizontal plane and the line, linking any edge (i) on the upper side of slat and the edge (a′) on the outer space of the adjacent upper slat, βᵢₐ is the included angle between the horizontal plane and the line, linking any edge (i) on the upper side and the edge (a) on the outer space on the upper side of the slat.

37. The multi-slat combination blind of up-down-movement type according to claim 2, characterized in that said micro-teeth are forward or backward teeth, including two adjacent orthogonal tooth surfaces: the first tooth surface (6) and the second tooth surface (5), the variation range of included angle α_{H} between the second tooth surface (5) of forward or backward teeth, which play a role of guiding sunlight, and the horizontal plane is (β_{ic}−H)/2≦α_{H}≦(β_{ic′}−H)/2, in which H is solar elevation angle, β_{ic} is the included angle between the horizontal plane and the line, linking any edge (i) on the upper side and the edge (c) on the interior space of slat, β_{ic′} is the included angle between the horizontal plane and the line, linking any edge (i) on the upper side of the slat and the edge (c′) on the interior space of the adjacent upper slat.
